(19) United States
(12) Patent Application Publication
(10) Pub. No.: US 2007/0226729 A1
(43) Pub. Date: Sep. 27, 2007

(54) Processing system, projector, program, and information storage medium

(75) Inventors: Motoki Ueda, Matsumoto-shi (JP); Toru Karasawa, Kamiina-gun (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 11/727,108

(22) Filed: Mar. 23, 2007

(30) Foreign Application Priority Data
Mar. 27, 2006 (JP) 2006-084999

(51) Int. Cl. G06F 9/44

(52) U.S. Cl. 717/168

(57) ABSTRACT

A projector storing a plurality of pieces of firmware includes an input section which inputs batch update data including update data for at least one piece of firmware and identification data for identifying update target firmware; a determination section which determines the update target firmware based on the identification data; and an update section which updates the update target firmware based on the update data.

Japanese Patent Application No. 2006-84999, filed on Mar. 27, 2006, is hereby incorporated by reference in its entirety.

### BACKGROUND OF THE INVENTION

The present invention relates to a processing system for updating firmware, a projector, a program, and an information storage medium.

A plurality of pieces of firmware may be stored in a projector. For example, first firmware may be stored in a flash memory in an interface section, and second firmware may be stored in a flash memory in a control section.

According to a related-art method, the projector must update the respective firmware using different methods. Specifically, the projector updates the first firmware by reading an update file stored in an external memory, and updates the second firmware by reading an update file through a serial port.

Therefore, the projector cannot update the respective firmware at the same time when using the since related-art method, whereby processing efficiency is decreased.

As another method, JP-A-2005-190308 discloses an image forming device which selects firmware to be used from a plurality of pieces of firmware stored in a PC, receives the selected firmware one by one, and execute a reboot process after completion of reception in order to efficiently perform an update process by eliminating an unnecessary reboot operation, for example.

However, this method results in poor transfer efficiency since the firmware is received one by one.

### SUMMARY

According to a first aspect of the invention, there is provided a processing system storing a plurality of pieces of firmware, the processing system comprising:

an input section which inputs batch update data including update data for at least one piece of firmware and identification data for identifying update target firmware;

a determination section which determines the update target firmware based on the identification data; and

an update section which updates the update target firmware based on the update data.

According to a second aspect of the invention, there is provided a projector comprising the above-described processing system.

According to a third aspect of the invention, there is provided a program causing a computer in a processing system storing a plurality of pieces of firmware to function as:

an input section which inputs batch update data including update data for at least one piece of firmware and identification data for identifying update target firmware;

a determination section which determines the update target firmware based on the identification data; and

an update section which updates the update target firmware based on the update data.

According to a fourth aspect of the invention, there is provided a computer-readable information storage medium storing the above-described program.

### BRIEF DESCRIPTION OF THE SEVERAL VIEWS OF THE DRAWING

FIG. 1 is a functional block diagram of a projector according to one embodiment of the invention.

FIG. 2 is a schematic flowchart showing a flow of firmware update processing according to one embodiment of the invention.

FIG. 3 is a diagram showing data structure of batch update data according to one embodiment of the invention.

### DETAILED DESCRIPTION OF THE EMBODIMENT

The invention may provide a processing system, a projector, a program, and an information storage medium all of which can more efficiently update a plurality of pieces of firmware.

According to one embodiment of the invention, there is provided a processing system storing a plurality of pieces of firmware, the processing system comprising:

an input section which inputs batch update data including update data for at least one piece of firmware and identification data for identifying update target firmware;

a determination section which determines the update target firmware based on the identification data; and

an update section which updates the update target firmware based on the update data.

According to one embodiment of the invention, there is provided a projector comprising the above-described processing system.

According to one embodiment of the invention, there is provided a program causing a computer in a processing system storing a plurality of pieces of firmware to function as:

an input section which inputs batch update data including update data for at least one piece of firmware and identification data for identifying update target firmware;

a determination section which determines the update target firmware based on the identification data; and

an update section which updates the update target firmware based on the update data.

According to one embodiment of the invention, there is provided a computer-readable information storage medium storing the above-described program.

According to these embodiments, since the above processing system and the like can update a plurality of pieces of firmware by inputting the batch update data only once, a plurality of pieces of firmware can be more efficiently updated.

The processing system may further comprise: a relay section; and a plurality of subsystems, the plurality of pieces of firmware being stored in the subsystems, and the relay section relaying firmware update information transferred between the subsystems.

Since information can be relayed between the subsystems by the relay section even if the subsystems have different input interfaces, use of an input interface can be omitted, and a plurality of pieces of firmware can be more efficiently updated.

In this processing system, the subsystems may include: a first subsystem including the input section, the determination section and the update section and storing at least one piece of firmware; and a second subsystem storing at least one piece of firmware,

the relay section setting the first subsystem and the second subsystem in an updatable state, and

the update section updating the update target firmware stored in at least one of the first subsystem and the second subsystem in the updatable state.

The above processing system and the like can more efficiently update a plurality of pieces of firmware by updating the update target firmware after setting the first and second subsystems in the updatable state.

In updating firmware in the first and second subsystems, the update section may update firmware in the second subsystem through the relay section at first, and then may cancel the update of the firmware in the first and second subsystems when the update section has failed in updating the firmware in the second subsystem, or may update the firmware in the first subsystem when the firmware in the second subsystem has been successfully updated.

In updating a plurality of pieces of firmware, by canceling all update operations if updating of one piece of firmware has failed, the above processing system and the like can prevent a plurality of pieces of firmware from being asynchronously updated.

The invention is described below with reference to the drawings taking the case of applying the invention to a projector as an example. Note that the embodiments described below do not in any way limit the scope of the invention laid out in the claims herein. In addition, not all of the elements of the embodiments described below should be taken as essential requirements of the invention.

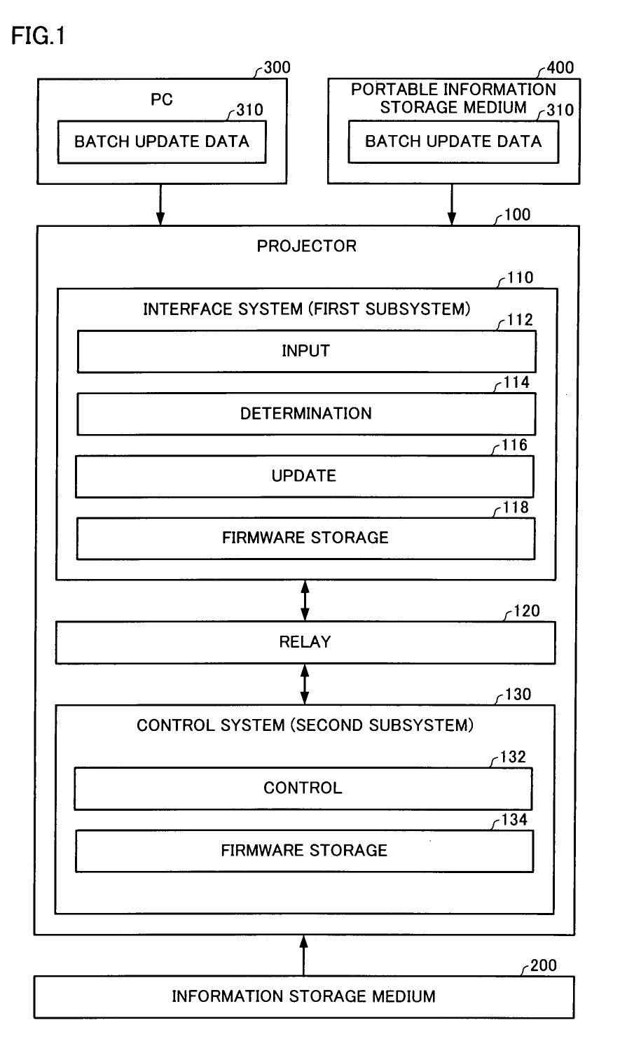

FIG. 1 is a functional block diagram of a projector 100 according to this embodiment.

The projector 100 includes an interface system 110 which is the first subsystem, a control system 130 which is the second subsystem, and a relay section 120 which relays information transferred between the interface system 110 and the control system 130. The control system 130 has a function of inputting data through a serial port. However, the control system 130 does not have a function of directly exchanging information with the interface system 110. Therefore, the relay section 120 is provided.

The interface system 110 includes an input section 112 which inputs batch update data 310 stored in a personal computer (PC) 300 or a portable information storage medium 400, a determination section 114 which determines the contents of the batch update data 310, a firmware storage section 118 which stores firmware including an OS, and an update section 116 which updates the firmware. The interface system 110, the relay section 120, and the control system 130 function as a processing system for updating firmware.

The control system 130 is a system which performs projection lamp switch-on control and the like. The control system 130 includes a firmware storage section 134 which stores firmware including an OS, and a control section 132 which updates the firmware stored in the firmware storage section 134.

As hardware for implementing each section, the following hardware may be used. For example, an input-output port, a card reader, a LAN port, or the like may be used as the input section 112; a CPU or the like may be used as the determination section 114, the update section 116, and the control section 132; a flash memory or the like may be used as the firmware storage sections 118 and 134; and a CPU, a transfer bus, or the like may be used as the relay section 120. As the portable information storage medium 400, a generally-used memory card (e.g. Compact Flash (registered trademark) card) or the like may be applied.

The function of each section may be implemented by causing the projector 100 to read a program from an information storage medium 200.

As the information storage medium 200, a storage medium using a laser, magnetism, or the like may be applied, such as a CD-ROM, DVD-ROM, IC card, ROM, RAM, memory card, or HDD. The program may be read from the information storage medium 200 using a contact method or a noncontact method. The function of each section may be implemented by causing the projector 100 to download a program through a network.

The flow of a firmware update process using each section is described below.

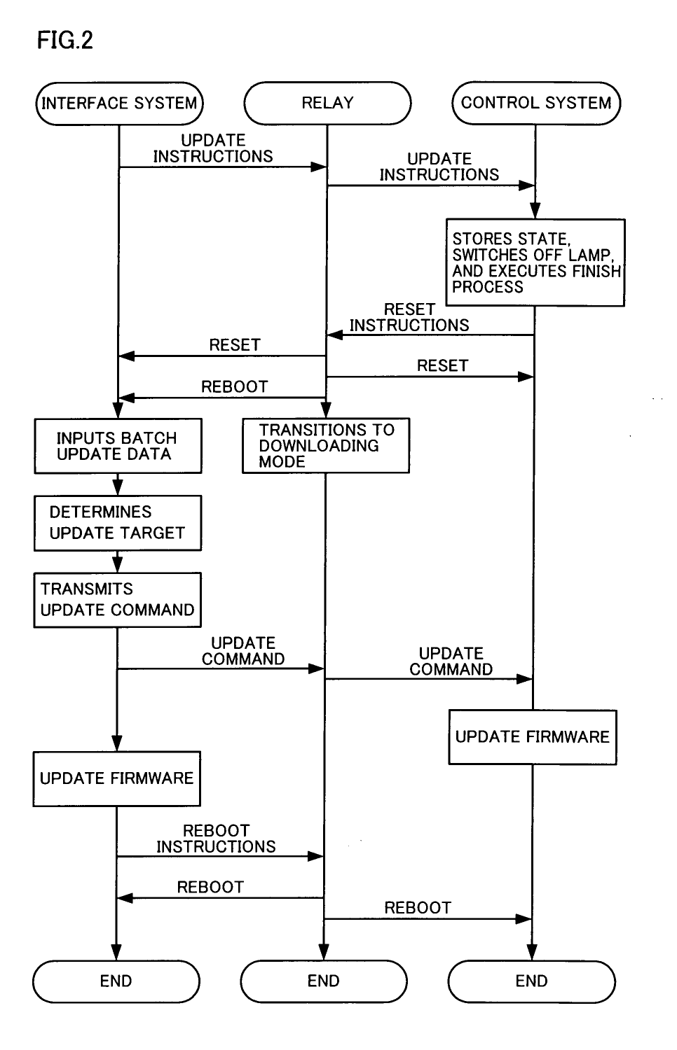

FIG. 2 is a schematic flowchart showing the flow of the firmware update process according to this embodiment.

A user connects the PC 300 or the portable information storage medium 400 to the projector 100, and issues firmware update instructions using an operation button and the like of the projector 100. The batch update data 310 downloaded from a server through a network is stored in the PC 300 or the portable information storage medium 400. A transmission/reception section of the PC 300 may download a plurality of pieces of firmware update data from the server, and an information generation section of the PC 300 may generate the batch update data 310 based on the update data.

The update section 116 outputs an update instruction command (firmware update information) to the relay section 120 in response to the update instructions, and the relay section 120 transfers the instruction command to the control system 130.

The control system 130 stores the present state, switches off the projection lamp, and executes a finish process of the control system 130.

The control system 130 issues reset instructions (firmware update information) to the relay section 120. The relay section 120 sequentially resets the interface system 110 and the control system 130 in response to the reset instructions. The relay section 120 reboots the interface system 110. The above operation causes the interface system 110 and the control system 130 to enter a state in which the firmware can be updated (updatable state).

The relay section 120 transitions from a normal mode to a downloading mode.

The interface system 110 activates a firmware update system. In more detail, the input section 112 inputs the batch update data 310.

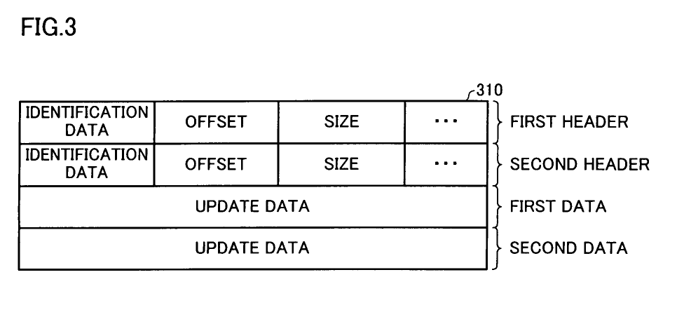

FIG. 3 is a diagram showing the data structure of the batch update data 310 according to this embodiment.

The batch update data 310 includes a first header and first data for the interface system 110, and a second header and second data for the control system 130.

The first header and the second header include “identification data” for identifying update target firmware, an “offset” indicating the offset of the first data or the second data from the head address of the batch update data 310, a “size” indicating the data size of the first data or the second data, and the like. These headers may include check data for checking whether or not data is normal, version information, authentication information, and the like. The size of each header is fixed.

The identification data indicates the presence or absence of update data using a numerical value. In more detail, the identification data indicates that update data does not exist when the identification data is 0, indicates that the first data exists when the identification data is 1, and indicates that the second data exists when the identification data is 2, for example. For example, when the value of the identification data in the first header is 1 and the value of the identification data in the second header is 2, the first data and the second data exist. When the value of the identification data in the first header is 1 and the value of the identification data in the second header is 0, only the first data exists. When the value of the identification data in the first header is 0 and the value of the identification data in the second header is 2, only the second data exists. When the value of the identification data in the first header is 0 and the value of the identification data in the second header is 0, update data does not exist.

Specifically, the determination section 114 determines the update target by referring to the identification data in the first header and the second header. This example illustrates the case of updating the firmware of the interface system 110 and the control system 130.

The update section 116 transmits an update command (firmware update information) based on the second header and the second data to the relay section 120. The relay section 120 transmits the update command to the control system 130.

The control section 132 updates the firmware stored in the firmware storage section 134 based on the update command. Note that the update command may be transmitted a number of times depending on the data size.

The update section 116 determines whether or not the firmware has been successfully updated based on a response command (firmware update information) for the update command from the control system 130 transmitted through the relay section 120. For example, when the response command indicates that the firmware has not been successfully updated, the update section 116 issues a cancellation command to the relay section 120 to cancel the firmware update operation in the control system 130, and does not update the firmware in the interface system 110. When the firmware has not been successfully updated, the update section 116 may retry to update the firmware.

When the firmware in the control system 130 has been successfully updated, the update section 116 updates the firmware stored in the firmware storage section 118 based on the first header and the first data.

When update of the firmware has been completed, the update section 116 issues a reboot instruction command (firmware update information) to the relay section 120. The relay section 120 sequentially reboots the interface system 110 and the control system 130 in response to the reboot instruction command.

The projector 100 updates the respective firmware stored in a plurality of systems according to the above-described procedure.

According to this embodiment, since the projector 100 can update a plurality of pieces of firmware by inputting the batch update data 310 only once, as described above, a plurality of pieces of firmware can be more efficiently updated.

According to this embodiment, since the projector 100 can update the firmware according to the procedure including updating the firmware of the control system 130, updating the firmware of the interface system 110, and rebooting the interface system 110 and the control system 130 instead of a procedure including updating the firmware of the control system 130, rebooting the control system 130, updating the firmware of the interface system 110, and rebooting the interface system 110, the firmware can be more efficiently updated.

According to this embodiment, since information can be relayed between the systems by the relay section 120 even if the systems have different input interfaces, use of an input interface can be omitted. Therefore, the projector 100 can more efficiently update a plurality of pieces of firmware.

According to this embodiment, the projector 100 can more efficiently update a plurality of pieces of firmware by updating the update target firmware after setting the systems in the updatable state.

According to this embodiment, when updating a plurality of pieces of firmware, the projector 100 cancels all update operations when the projector 100 has failed in updating one piece of firmware. Therefore, a situation can be prevented in which a plurality of pieces of firmware is asynchronously updated.

The invention is not limited to the above-described embodiments. Various modifications and variations may be made.

In the above embodiment, the identification data is provided in update data units, for example. Note that only one piece of identification data may be used irrespective of the number of pieces of update data. In this case, the first data and the second data may exist in the batch update data 310 when the value of the identification data is 0, only the first data may exist in the batch update data 310 when the value of the identification data is 1, and only the second data may exist in the batch update data 310 when the value of the identification data is 2, for example.

When the projector 100 reads the batch update data 310 from the PC 300, the PC 300 may display the firmware update state. When the projector 100 reads the batch update data 310 from the portable information storage medium 400, the firmware update state may be indicated by switching on an LED of the projector 100 while changing the color.

A system to which the invention may be applied is not limited to the interface system 110 and the control system 130. The invention may be applied to various systems storing firmware. The number of systems storing firmware is not limited to two, and may be three or more. Even when the number of systems is three or more, the projector 100 can efficiently update only the update target firmware using the same interface. Moreover, a user can update the firmware without taking the update target into consideration, whereby the efficiency of the update operation can be increased.

A projector to which the invention may be applied is not limited to a front projection type projector, and may be a rear projection type projector. The projector is not limited to a liquid crystal projector, and may be a CRT projector, a DLP projector, an LED projector, and the like.

The functions of the projector 100 may be distributed throughout a plurality of devices (e.g. projector and PC).

Although only some embodiments of the invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. A processing system storing a plurality of pieces of firmware, the processing system comprising:
an input section which inputs batch update data including update data for at least one piece of firmware and identification data for identifying update target firmware;
a determination section which determines the update target firmware based on the identification data; and
an update section which updates the update target firmware based on the update data.

2. The processing system as defined in claim 1, further comprising:
a relay section; and
a plurality of subsystems,
the plurality of pieces of firmware being stored in the subsystems, and
the relay section relaying firmware update information transferred between the subsystems.

3. The processing system as defined in claim 2,
the subsystems including: a first subsystem including the input section, the determination section and the update section and storing at least one piece of firmware; and a second subsystem storing at least one piece of firmware,
the relay section setting the first subsystem and the second subsystem in an updatable state, and
the update section updating the update target firmware stored in at least one of the first subsystem and the second subsystem in the updatable state.

4. The processing system as defined in claim 3,
wherein, in updating firmware in the first and second subsystems, the update section updates firmware in the second subsystem through the relay section at first, and then cancels the update of the firmware in the first and second subsystems when the update section has failed in updating the firmware in the second subsystem, or updates the firmware in the first subsystem when the firmware in the second subsystem has been successfully updated.

5. A projector comprising the processing system as defined in claim 1.

6. A program causing a computer in a processing system storing a plurality of pieces of firmware to function as:
an input section which inputs batch update data including update data for at least one piece of firmware and identification data for identifying update target firmware;
a determination section which determines the update target firmware based on the identification data; and
an update section which updates the update target firmware based on the update data.

7. A computer-readable information storage medium storing the program as defined in claim 6.
